(19) United States
(12) Patent Application Publication
(10) Pub. No.: US 2006/0216381 A1
(43) Pub. Date: Sep. 28, 2006

(54) Aqueous lecithin dispersions

(76) Inventor: Ravindra L. Arudi, Woodbury, MN (US)

Correspondence Address: CARGILL, INCORPORATED, LAW/24, 15407 MCGINTY ROAD WEST, WAYZATA, MN, 55391, US

(21) Appl. No.: 10/564,300

(22) PCT Filed: Jul. 24, 2003
(86) PCT No.: PCT/US03/23079

§ 371 Date: Jan. 11, 2006

(51) Int. Cl. A23L 2/00

(52) U.S. Cl. 426/330.6

(57) ABSTRACT

There is disclosed an aqueous lecithin dispersion comprising water and specified lecithins.

### CROSS REFERENCE TO RELATED APPLICATION

This application is a continuation-in-part application of U.S. application Ser. No. 10/202,294, that was filed with the United States Patent and Trademark Office on Jul. 23, 2002.

### FIELD OF THE INVENTION

The present invention relates to aqueous dispersions comprising specific lecithin products.

### BACKGROUND OF THE INVENTION

The annual world production of lecithin from different plant sources is estimated to be over 250,000 tons, 90% of which is lecithin. Although many industries such as paints/links, magnetic media coatings, pharmaceuticals, cosmetics and health/nutrition supplements, benefit from soy lecithin, it is especially useful in the food industry. The emulsifying properties of natural lecithin need improvement particularly in the area of oil-in-water emulsions where the dispersed phase is oil and the continuous phase is water, because the emulsifying activities of the various phospholipid components compete with each other.

Aqueous solutions or emulsions of numerous lecithin products produced by the conventional water-degumming process suffer from high viscosity especially at shear rates of 0-100 sec⁻¹. At high concentrations such solutions or emulsions of lecithin are not very useful in food applications (oil-in-water emulsions such as beverages and sauces/spreads) and lecithin-coated substrates (e.g., instantized food powders) because of unacceptably high viscosity and separation of the oil layer (creaming) over time. As a result, natural plant lecithin has not been successfully used as an oil-in-water emulsifier; it is mostly used as a water-in-oil emulsifier (chocolate, confectionary) where very little water is encountered.

Numerous attempts have been made in prior art to improve the oil-in-water (O/W) emulsifier activity of plant lecithin, concentrating on chemical/enzymatic modification, fractionation by organic/supercritical solvents and physical methods. For example, chemical modification of lecithin includes nonspecific hydrolysis, acetylation and hydroxylation. Accordingly, it would be beneficial to provide a system that would be useful where the oil-in-water emulsions have been deficient.

### SUMMARY OF THE INVENTION

The present invention relates to dispersions comprising water and from greater than 0 to about 65% by weight of a lecithin that is either a membrane separated lecithin having a ratio of alkali metals to alkaline earth metals ranging from greater than 0 to about 10, preferably greater than 0 to about 5, or in a second embodiment, a lecithin product having a ratio of alkali metals to alkaline earth metals ranging from about 1.6 to about 3.0, preferably about 1.8 to about 2.8.

### DETAILED DESCRIPTION OF THE INVENTION

The present invention relates to dispersions comprising water and from greater then 0 to about 65% by weight of a lecithin that is either a membrane separated lecithin having a ratio of alkali metals to alkaline earth metals ranging from greater than 0 to about 10, preferably greater than 0 to about 5, or in a second embodiment, a lecithin product having a ratio of alkali metals to alkaline earth metals ranging from about 1.6 to about 3.0, preferably about 1.8 to about 2.8.

In determining the content of the alkali metals and alkaline earth metals of the lecithin product, the following test procedure is used.

Elemental Analysis Standard Procedure SRC

Elemental analysis was performed by Inductively Coupled Plasma-Emission Spectroscopy (ICP-ES) with target elements of aluminum, calcium, chromium, iron, lead, magnesium, nickel, potassium, phosphorus, silicon, sodium, and zinc. This analysis was performed according to the American Oil Chemists' Society (AOCS) Official Method Ca 20-99. Each sample was weighed on an analytical balance to the nearest 0.0001 g. Because of the range of concentration, two dilution levels are required. Approximately 0.8 g of sample was weighted out and recorded. To the sample approximately 4.2 g of kerosene was weighted and recorded. The sample/kerosene mixture was vortexed until the sample is completely dissolved. Approximately 4.2 g mineral oil was added to the sample/kerosene solution and recorded. This concentration is used to analyze the lower level elements, Al, Cr, Fe, Pb, Na, Ni, Si, and Zn. For the higher concentration elements, Ca, Mg, P and K, another dilution is made by taking approximately 0.5 g of the first dilution, recording the weight, and adding approximately 9.5 g of a 50/50 kerosene/mineral oil and record the total weight. All of the final dilutions are mixed until homogeneous. The samples are placed into a heated, 40° C., sample hot plate along with the standards and allowed to come to temperature, approximately 10 minutes, prior to the introduction into the ICP. Samples were run in triplicate.

Calculation:

The ICP data is reported typically as ppm calcium, magnesium, potassium, sodium, and phosphorous, along with other metals. The ppm values are divided by the atomic weight of the respective element (Ca:40, K:39, P:31 and Mg:24) and the atomic equivalents are used to calculate the ratio of monovalent to divalent (alkali metals to alkaline earth metals).

The lecithin products used in the present invention may be prepared by any suitable manner. For example, a vegetable oil miscella may be passed through a membrane, preferably polymeric or semi-permeable, to obtain a retentate and a permeate. The lecithin products are in the retentate. Exemplary of such methods are those appearing in U.S. Pat. No. 6,207,209 to Jirjis, et al.; U.S. Pat. Nos. 4,496,498 and 4,533,501 to Sen Gupta. Specific examples describing the preparation of lecithin products of the invention are provided as follows:

### EXAMPLE A

Two samples of miscella were prepared by using the present technique. Miscella samples were obtained from two different oil seeds plants.

A membrane was conditioned and used for removing phospholipids from each of the two samples of miscella. The membrane purchased was a PAN membrane from Osmonics, Inc. The membrane can be characterized as having an average pore size of 0.3 micron, and in the form of a spiral wound 25 inch×40 inch membrane element. The membrane was conditioned by soaking the membrane in an intermediate solvent (propanol) for 24 hours. Then the membrane was soaked in mixture of intermediate solvent (propanol) and extraction solvent (hexane) for 24 hours. Finally, the membrane was soaked in extraction solvent (hexane) for 24 hours.

The two samples of miscella were individually processed. For the soybean oil miscella, the test was conducted at retentate concentration of 10 × of the feed concentration and the permeate rate of 10× concentration was 100 liter/hour m². For the corn miscella, the test was conducted at retentate concentration of 7.4× of the feed at a permeate rate of 80 liter/hour m².

### EXAMPLE B

Samples of soybean oil miscella were taken on different days and were treated by using the present technique.

Spiral wound 8 inch×40 inch QX membranes were purchased from Osmonics, Inc. The membranes were conditioned and used for removing phospholipids by soaking them in an intermediate solvent (100% isopropanol) for 12 hours. At 6 hours, the intermediate solvent was recirculated at a flow rate of 15 m³/hour per element and forced through the membrane pores for about 15 minutes using a pump (this recirculation or forcing through is referred to as “forced Permeation” for purposes of the Example B). Then the resulting membrane was soaked in a 50:50 mixture of intermediate solvent (100% isopropanol) and extraction solvent (100% commercial hexane) for 12 hours. After 6 hours this soaking included recirculation at a flow rate of 15 m³/hour per element and forced permeation for about 15 minutes. Finally, the resulting membranes were soaked in extraction solvent (100% commercial hexane) for 12 hours, also with recirculation and forced permeation of the extraction solvent at 6 hours for about 15 minutes with 15 m³/hour recirculation flow. The resulting membranes treated with this process are “conditioned membranes” for purposes of this Example B.

The soybean miscella containing about 75 wt. % hexane, 24.3 wt. % crude oil, and 0.7 wt. % phospholipids, was passed through the first conditioned membrane at a trans-membrane pressure of 4 Kgf/cm² at a rate of 0.6 m³/hour per element. The resulting retentate stream had about 7 wt. % phospholipids and 23 wt. % oil (i.e., the test was conducted at retentate concentration of 10× of the feed concentration). Excess hexane was added to this retentate in the proportion of two (2) portions of hexane to one (1) portion of retentate resulting in a stream containing 88 wt. % hexane. This retentate stream was passed through a second conditioned membrane at a trans-membrane pressure of 4 Kgf/cm² at a rate of 0.35 m³/hour per element, resulting in a retentate stream having about 65 wt. % hexane, 23 wt. % phospholipids and 12 wt. % oil which is equivalent to lecithin free of hexane with 66% acetone insolubles. This retentate stream was desolventized at a rate of 1800 kg/hour, 95° C. and 260 mm Hg absolute pressure. The resulting concentration of hexane was 5%. The retentate stream was further desolventized at a temperature of 110° at an absolute pressure of 20 mm Hg and sparge stream of 80 kg/hour by using a stripper to product 600 kg/hour of lecithin product with less than 5 ppm of hexane.

Any vegetable oil, which may be solid or liquid at ambient temperature, can be used in the present emulsions. Suitable vegetable oils for use include, for example, soybean oil, sunflower oil, rapeseed oil, cottonseed oil, olive oil, corn oil ground nut oil, safflower oil, linola oil, linseed oil, palm oil, coconut oil, all of which may be partially or completely hydrogenated or modified otherwise, and mixtures thereof. Particularly useful are soybean oil and partially hydrogenated soybean oil. Suitable oils of animal origin for use include, for example, butter fat and fish oil. The total of the animal fats should be below 30 wt. % of total oils in the food composition.

In other embodiments of the present invention, the aqueous lecithin dispersions comprise amounts of greater than 0 to about 25% by weight lecithin, and preferably from about 10 to about 20% by weight lecithin, the balance comprising water. Further, in other embodiments, the lecithin used in the present dispersions, include greater than 0 to about 90% by weight of oil, or from greater than 0 to about 50% by weight of oil, or from greater than 0 to about 32% by weight of oil, or from greater than 0 to about 5% by weight of oil.

The dispersions of the present invention are prepared using any conventional manner. For example, as herein in the Example, the lecithin is dissolved in water by mixing at 2000 revolutions per minute (rpm) for three (3) minutes using any suitable mixer.

The following examples are presented to illustrate the present invention and to assist one of ordinary skill in making and using the same. The examples are not intended in any way to otherwise limit the scope of the invention.

### EXAMPLE

In this example, 45 g of a soybean lecithin containing about 32% oil and having a ratio of alkali metals to alkaline earth metals of about 1.7 was dispersed in 255 g of water by mixing with an UltraTurrax T-50 homogenizer (manufactured by Ika-Werke, Germany) at 2000 rpm for 2 minutes. After allowing 3 minutes for hydration of lecithin the dispersion was mixed at 2000 rpm for another 2 minutes. The dispersion was thus mixed for a total of 10 minutes (5 treatments of 2 minutes each). The resulting uniform dispersion of lecithin was allowed to stand for 2 days. The final dispersion was tested for low shear viscosity (Physica MCF-300 Rheometer, shear rate 0-100 sec⁻¹), particle size distribution (Lasentec Model 2001A Particle Size Analzyer) and dispersion settling rate (Turbiscan Lab Expert, by Formulaction, France). The results are as follows:

1. Viscosity: 20-25 cps at shear rate 0-100 sec⁻¹.

2. Particle Size Distribution: measured using the Lasentec Particle Size Analyzer (5 second time frame), directly on the dispersion without diluting. The dispersion was stirred slowly using a magnetic stirring bar, while making the particle size measurement.

| | % Signal Intensity |
|---|---|
| | With respect to |
| Particle Size, Microns | Intensity at 7 microns) |
| 300 | 2 |
| 200 | 5 |
| 100 | 32 |
| 50 | 53 |
| 20 | 68 |
| 10 | 79 |
| 7 | 100 |
| 4 | 84 |
| 2 | 74 |
| 1 | 34 |

3. Settling Rate: 10 g of the dispersion was tested on the Turbiscan Analyzer by measuring the decrease in % backscattered light at a distance of 1 cm from the d ispersion meniscus.

| Time, hr | % Backscattered Light |
|---|---|
| 0 | 56.2 |
| 0.5 | 54.4 |
| 1.0 | 46.5 |
| 2.0 | 43.5 |
| 3.0 | 42.5 |

These values were plotted on a log scale and the slope of the resulting straight line was determined to obtain the settling rate constant kₛ=4.8 (% backscattered light per hour).

In view of the above data, it is apparent that the aqueous lecithin dispersions of the present invention have low viscosity over the low shear rate range of 0-100 sec⁻¹; have increased oil-holding capacity; and have the ability to control particle size distribution. As a result, the aqueous lecithin dispersions of the present invention are expected to be useful in many applications involving oil-in-water emulsions, instantized food products, aqueous latex paints, aqueous inks, aqueous coating, and aqueous cosmetics, aqueous pharmaceuticals and aqueous nutraceuticals.

The invention has been described with reference to various specific and illustrative embodiments and techniques. However, one skilled in the art will recognize that many variations and modifications may be made while remaining within the spirit and scope of the invention.

We claim:

1. A dispersion comprising water and from greater than 0 to about 65% by weight of a membrane separated lecithin having a ratio of alkali metals to alkaline earth metals ranging from greater than 0 to about 10.

2. The dispersion according to claim 1 wherein the lecithin has a ratio of alkali metals to alkaline earth metals ranging from greater than 0 to about 5.

3. The dispersion according to claim 1 wherein the lecithin is present in an amount of from greater than 0 to about 25% by weight.

4. The dispersion according to claim 1 wherein the lecithin is present in an amount of from about 10 to about 20% by weight.

5. The dispersion according to claim 1 wherein the lecithin has greater than 0 to about 90% by weight of oil.

6. A dispersion comprising water and from greater than 0 to about 65% by weight of a lecithin having a ratio of alkali metals to alkaline earth metals ranging from about 1.6 to about 3.0.

7. The dispersion according to claim 6 wherein the lecithin has a ratio of alkali metals to alkaline earth metals ranging from about 1.8 to about 2.8.

8. The dispersion according to claim 6 wherein the lecithin is present in an amount of from greater than 0 to about 25% by weight.

9. The dispersion according to claim 6 wherein the lecithin is present in an amount of from about 10 to 20% by weight.

10. The dispersion according to claim 6 wherein the lecithin has greater than 0 to about 90% by weight of oil.
